(19) United States
(12) Patent Application Publication
(10) Pub. No.: US 2018/0187424 A1
(43) Pub. Date: Jul. 5, 2018

(54) SKID-RESISTANT FLOOR BOARD WITH PARALLEL LOCKING ENGAGEMENT STRUCTURE

(71) Applicant: Dongguan Mei Jer Plastic Products Co., Ltd., Dongguan (CN)

(72) Inventor: Ben-Yuan Chen, Dongguan (CN)

(21) Appl. No.: 15/397,749

(22) Filed: Jan. 4, 2017

(51) Int. Cl. E04F 15/10; E04F 15/22; E04F 15/02; B32B 7/12; B32B 5/02

(52) U.S. Cl. CPC E04F 15/107; E04F 15/22; E04F 15/02038; E04F 15/105; B32B 2419/00; B32B 7/12; B32B 5/02; E04F 2201/0107; E04F 2201/023; E04F 15/02172

(57) ABSTRACT

Disclosed is a skid-resistant floor board with parallel locking engagement structure, including a main body and an adhesive layer, which is stacked on and overlaps an undersurface of the main body. The adhesive layer has a surface that is provided for contacting and engaging a ground surface and includes a plurality of raised ribs projecting therefrom. Through the inclusion of a glass fiber layer in the main body and extension of the glass fiber layer into the parallel locking projection, the tensile strength and the bending strength of the product, after being jointed, are significantly increased and are much greater than a product without the glass fiber layer so that the product performance is greatly improved and improved resistance against skidding can be achieved.

### (a) TECHNICAL FIELD OF THE INVENTION

The present invention relates to the technical field of floor boards, and more particular to a skid-resistant floor board with parallel locking engagement structure.

### (b) DESCRIPTION OF THE PRIOR ART

It is commonly known that a floor covering material that is made of high molecular polymers (mainly resinous materials) is generally referred to as a plastic floor board, which exhibits the following advantages: (1) the cost being moderate and being relatively cheap as compared to carpet, wooden floor boards, and stone and ceramic floor materials; (2) having good decorative effect, showing diversified variations of type, texture, pattern, color, quality, and shape, and having a high density unique structure on a surface thereof to suit for all sorts of favorites of different people and needs for various applications, such as mimicking various patterns and textures, for example wood texture, marble texture, carpet texture, and granite texture, where the result of mimicking is very real in mimicking natural materials; (3) providing various functionalities, including perception of conformableness, feeling of warmth, thermal insulation, sound isolation, and humidity isolation; (4) having easy laying operation, which requires no cement and sand, requires no civil engineering, can be done with adhesive paste so as to be efficient and easy, allowing the general consumers to participate in the overall design, selection of materials, and laying; (5) having less weight and being ten times lighter than properly constructed wooden floor; twenty time lighter than properly constructed ceramic tiles; and twenty fiver times lighter than properly constructed stone materials, making it suitable for high buildings and office buildings of more than three levels to help reduce the weight supported by the buildings and ensure safety, and allowing for easy moving; and (6) being easy to maintain by being easily wiped and washed and being easy to dry and showing excellent resistance against wear and abrasion, so as to show extended service life. Apparently, the plastic floor board demonstrates numerous features and advantages and has a prosperous future of a wide market.

Skid resistance performance has long been an important issue for plastic floor boards that has been extensively studied and researched in this field. Here, skid resistance performance indicates the performance of a plastic floor board resisting skidding movement and skid resistance coefficient is an important index to indicate the level of skid resistance performance. Most of the floor boards that are currently available in the market have demonstrated excellent skid resistance. For easy and efficient installation of the floor board, coupling and installation of the floor boards are achieved through parallel locking engagement. However, in light of design flaws of the structure, the floor boards, once puzzled up and jointed, may have insufficient tensile strength and bending strength, making the performance of use of a product thereof poor.

### SUMMARY OF THE INVENTION

In view of the drawbacks of the prior art, the present invention aims to provide a skid-resistant floor board with parallel locking engagement structure to effectively overcome the issues of insufficiency of tensile strength and bending strength of the prior art floor boards after being puzzled up and jointed.

To achieve the above objective, the present invention adopts a technical solution as follows:

A skid-resistant floor board with parallel locking engagement structure comprises a main body and an adhesive layer. The adhesive layer is stacked on and overlaps an undersurface of the main body. The adhesive layer has a surface for contacting and engaging a ground surface and comprising a plurality of raised ribs formed thereon and projecting therefrom. The plurality of raised ribs forms a plurality of enclosed cavity-like suction cups. The main body comprises at least two joint surfaces. One of the joint surfaces comprises a parallel locking projection integrally formed thereon and projecting outward therefrom. Another one of the joint surfaces comprises a parallel locking groove formed therein through recessing to be mateable and engageable with the parallel locking projection. The main body comprises a glass fiber layer embedded therein. The glass fiber layer extends into the parallel locking projection.

As an optional alternative, the glass fiber layer is arranged in a middle of the parallel locking projection.

As an optional alternative, the glass fiber layer is exposed at each of lateral surfaces of the parallel locking projection and is substantially flush with each of the lateral surfaces of the parallel locking projection.

As an optional alternative, the glass fiber layer is located on a top surface of the parallel locking projection and lateral surfaces of the parallel locking projection are substantially flush with lateral surfaces of the glass fiber layer respectively.

As an optional alternative, the glass fiber layer is located on a bottom surface of the parallel locking projection and lateral surfaces of the parallel locking projection are substantially flush with lateral surfaces of the glass fiber layer respectively.

As an optional alternative, the main body is formed of a material of polyvinyl chloride.

As an optional alternative, the adhesive layer comprises a pressure-sensitive, heat-sensitive adhesive material.

As an optional alternative, the raised ribs comprise enclosed irregular hexagonal raised ribs.

As an optional alternative, the plurality of raised ribs comprise flexible hot-pressed patterns on the undersurface of the main body through hot pressing and the hot-pressed patterns comprise the plurality of enclosed irregular hexagonal raised ribs connected to each other through successive repeating.

Compared to the prior art, the present invention exhibits significant advantages and beneficial effects. Specifically, the following features can be appreciated from the above technical solution.

Through inclusion of a glass fiber layer in the main body and extension of the glass fiber layer into the parallel locking projection, the tensile strength and the bending strength of the product, after being jointed, are significantly increased and are much greater than a product without the glass fiber layer so that the product performance is greatly improved and improved resistance against skidding can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a first preferred embodiment of the present invention.

FIG. 2 is a bottom view of the first preferred embodiment of the present invention.

FIG. 3 is a cross-sectional view illustrating a condition of use of the first preferred embodiment of the present invention.

FIG. 4 is a perspective view showing a second preferred embodiment of the present invention.

FIG. 5 is a perspective view showing a third preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

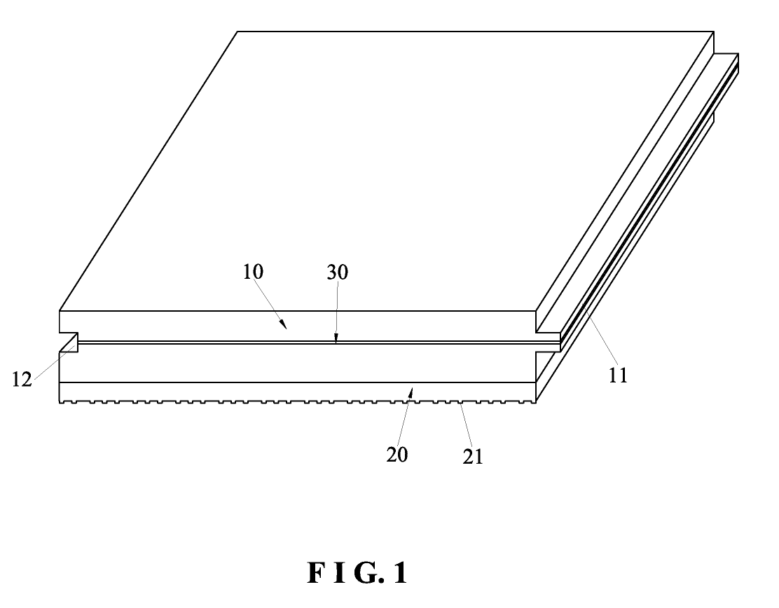

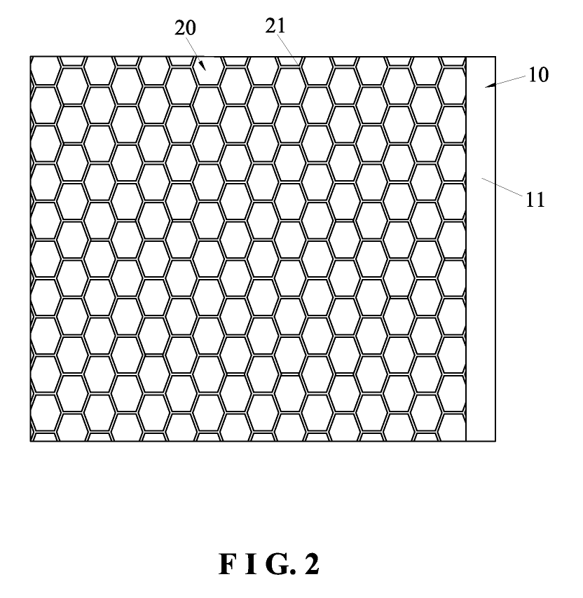

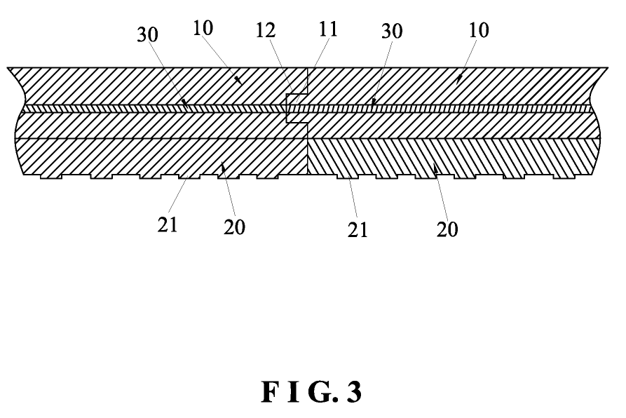

Referring to FIGS. 1-3, a structure according to a first preferred embodiment of the present invention is shown, comprising a main body 10 and an adhesive layer 20.

The adhesive layer 20 is stacked on and overlapping an undersurface of the main body 10. The adhesive layer 20 has a surface, which is provided for engagement with ground and comprises a plurality of raised ribs 21 formed thereon and projecting therefrom. The plurality of raised ribs 21 form a plurality of enclosed cavity-like suction cups, which provides suction forces for well attachment to the ground and thus achieves an excellent effect of skid resistance. In the instant embodiment, the main body 10 is formed of a material of polyvinyl chloride; the adhesive layer 20 comprises a pressure-sensitive, heat-sensitive adhesive material. The raised ribs 21 comprise enclosed irregular hexagonal raised ribs, and the plurality of raised ribs 21 are formed as flexible hot-pressed patterns on the undersurface of the main body 10 through hot pressing. The hot-pressed patterns comprise a plurality of such enclosed irregular hexagonal raised ribs connected to each other through successive repeating.

The main body 10 comprises at least two joint surfaces, wherein one of the joint surfaces comprises a parallel locking projection 11 that is integrally formed thereon and projects outward therefrom and the other one joint surface comprises a parallel locking groove 12 that is formed thereon through recessing to be mateable and engageable with the parallel locking projection 11. The main body 10 comprises a glass fiber layer 30 embedded therein. The glass fiber layer 30 extends into the parallel locking projection 11. In the instant embodiment, the glass fiber layer 30 is arranged at a middle of the parallel locking projection 11 and the glass fiber layer 30 has a specification of 150 g/m². The glass fiber layer 30 is exposed on each of lateral surfaces of the parallel locking projection 11 and is substantially flush with each of the lateral surfaces of the parallel locking projection 11.

The product of the present invention has an overall thickness of 5 mm A thickness of the parallel locking projection 11 and a width of the parallel locking groove 12 are both 2 mm+thickness of the glass fiber layer 30. To use, the parallel locking projection 11 of one floor board is inserted into and set in engagement with, and thus connected to, the parallel locking groove 12 of another floor board positioned immediately next to the previous floor board.

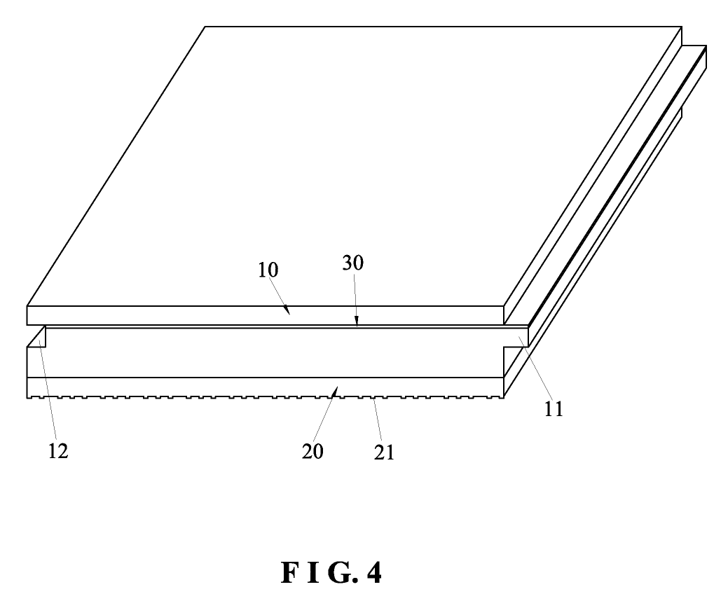

Referring to FIG. 4, a structure according to a second preferred embodiment of the present invention. The structure of the instant embodiment is generally similar to the structure of the previously described first preferred embodiment with a difference therebetween being described as follows:

In the instant embodiment, the glass fiber layer 30 is located on a top surface of the parallel locking projection 11 and lateral surfaces of the parallel locking projection 11 are substantially flush with lateral surfaces or edges of the glass fiber layer 30 respectively.

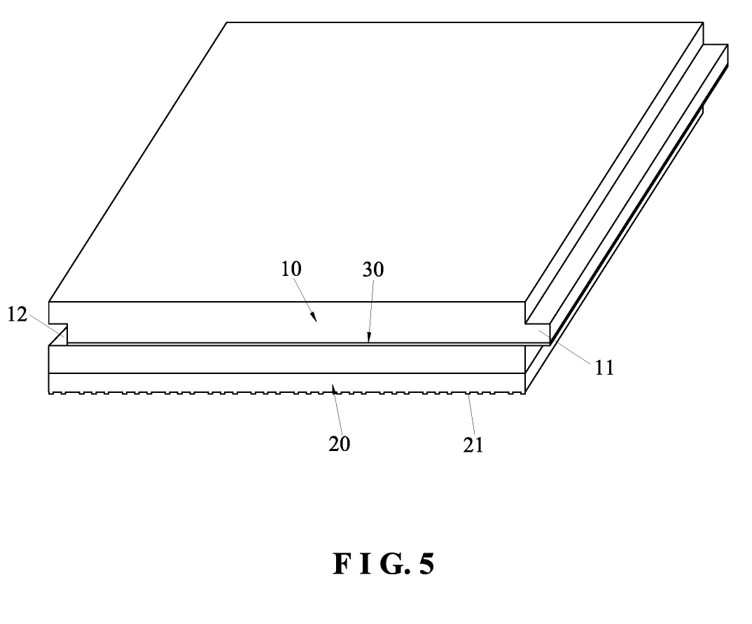

Referring to FIGS. 5, a structure according to a third preferred embodiment of the present invention. The structure of the instant embodiment is generally similar to the structure of the previously described first preferred embodiment with a difference therebetween being described as follows:

In the instant embodiment, the glass fiber layer 30 is located on a bottom surface of the parallel locking projection 11 and lateral surfaces of the parallel locking projection 11 are substantially flush with lateral surfaces or edges of the glass fiber layer 30 respectively.

Tests of each of the embodiments of the present invention are conducted for tensile strength and bending strength according to GB/T4454-1996 and the results of tests are provided in the following table:

| Embodiment | Tensile Strength (MPa) | Bending Strength (MPa) |
|---|---|---|
| First Embodiment | 95 | 135 |
| Second Embodiment | 91 | 126 |
| Third Embodiment | 92 | 127 |
| Without Glass Fiber | 65 | 93 |

One can see from the above table that through addition of a glass fiber layer 30 in the parallel locking projection 11, the tensile strength and the bending strength of the product, after being jointed, are significantly increased and are much greater than a product without the glass fiber layer so that the product performance is greatly improved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A floor board with parallel locking engagement structure, comprising a main body and an adhesive layer, the adhesive layer being stacked on and overlapping an undersurface of the main body, the adhesive layer having a surface adapted to contact and engage a ground surface and comprising a plurality of raised ribs formed on and projecting the surface of the adhesive layer, the plurality of raised ribs forming a plurality of enclosed cavity-like suction cups, which are attachable to the ground surface through a suction force induced between the suction cups and the ground surface so as to resist skidding of the floor board relative to the ground surface, wherein the main body comprises at least two joint surfaces, one of the joint surfaces comprising a parallel locking projection integrally formed thereon and projecting outward therefrom, another one of the joint surfaces comprising a parallel locking groove formed therein through recessing to be mateable and engageable with the parallel locking projection, the main body comprising a glass fiber layer embedded therein, the glass fiber layer extending into the parallel locking projection;
wherein the glass fiber layer is a separate layer sandwiched between an upper portion and a lower portion of the main body such that the main body comprises a three-layered stack including the lower portion, the glass fiber layer, and the upper portion sequentially stacked on each other.

2. The floor board with parallel locking engagement structure according to claim 1, wherein the glass fiber layer is arranged in a middle of the parallel locking projection.

3. The floor board with parallel locking engagement structure according to claim 2, wherein the glass fiber layer is exposed at each of lateral surfaces of the parallel locking projection and is substantially flush with each of the lateral surfaces of the parallel locking projection.

4. The floor board with parallel locking engagement structure according to claim 1, wherein the glass fiber layer is located on a top surface of the parallel locking projection and lateral surfaces of the parallel locking projection are substantially flush with lateral surfaces of the glass fiber layer respectively.

5. The floor board with parallel locking engagement structure according to claim 1, wherein the glass fiber layer is located on a bottom surface of the parallel locking projection and lateral surfaces of the parallel locking projection are substantially flush with lateral surfaces of the glass fiber layer respectively.

6. The floor board with parallel locking engagement structure according to claim 1, wherein the main body is formed of a material of polyvinyl chloride.

7. The floor board with parallel locking engagement structure according to claim 1, wherein the adhesive layer is formed of an adhesive material.

8. The floor board with parallel locking engagement structure according to claim 1, wherein the raised ribs comprise enclosed irregular hexagonal raised ribs.

9. The floor board with parallel locking engagement structure according to claim 8, wherein the plurality of raised ribs comprise flexible hot-pressed patterns on the undersurface of the main body through hot pressing and the hot-pressed patterns comprise the plurality of enclosed irregular hexagonal raised ribs connected to each other through successive repeating.
